(19) United States
(12) Patent Application Publication
(10) Pub. No.: US 2005/0041823 A1
(43) Pub. Date: Feb. 24, 2005

(54) Signal adjusting apparatus

(75) Inventor: Yoshinori Kataoka, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/919,299

(22) Filed: Aug. 17, 2004

(30) Foreign Application Priority Data
Aug. 19, 2003 (JP) P2003-207948

(51) Int. Cl. G03B 17/00; H04B 1/20

(52) U.S. Cl. 381/119; 369/4

(57) ABSTRACT

Herein disclosed is a signal adjusting apparatus which comprises a movable member which is movable in a movable range to have the electrical signal adjusted in accordance with a position of the movable member, a load putting device which puts a load to the movable member under the state that the movable member is movable in the movable range, and a load adjusting device which adjusts the magnitude of the load putted to the movable member.

### BACKGROUND OF THE INVENTION

1. Field of the Invention

The present invention relates to a signal adjusting apparatus, and more particularly to a signal adjusting apparatus which is operative to adjust an electrical signal.

2. Description of the Related Art

Up to now, there have been proposed a variety of conventional signal adjusting apparatuses each of which is operative to adjust an electrical signal. One typical example of the conventional signal adjusting apparatuses is adapted to an audio mixer which is operative to adjust an audio signal. This type of signal adjusting apparatus is disclosed in U.S. Pat. No. 6,301,365.

The conventional signal adjusting apparatus thus proposed comprises an operation lever which is movable in a movable range, and a slide volume which detects a position of the operation lever and adjusts a volume level of the audio signal in accordance with the position of the operation lever.

The conventional signal adjusting apparatus described above, however, encounters such a problem that the operation lever cannot adjust the magnitude of the load putted to the operation lever in accordance with a user's preference, resulting from the fact that the slide volume is a contact type of detector with a constant load putted to the operation lever under the state that the operation lever is moved by a user.

### SUMMARY OF THE INVENTION

It is, therefore, an object of the present invention to provide a signal adjusting apparatus which can adjust the magnitude of the load putted to the operation lever in accordance with a user's preference.

The above object of the present invention can be achieved by a signal adjusting apparatus which adjusts an electrical signal, comprising: a movable member which is movable in a movable range to have the electrical signal adjusted in accordance with a position of the movable member; a load putting device which puts a load to the movable member under the state that the movable member is movable in the movable range; and a load adjusting device which adjusts the magnitude of the load putted to the movable member.

### BRIEF DESCRIPTION OF THE DRAWINGS

The features and advantages of the signal adjusting apparatus according to the present invention will be more clearly understood from the following description taken in conjunction with the accompanying drawings in which:

FIG. 1 is a perspective view showing the signal adjusting apparatus in one preferred embodiment according to the present invention;

FIG. 2 is an enlarged perspective view showing a main part of the signal adjusting apparatus in one preferred embodiment according to the present invention;

FIG. 3 is an enlarged perspective view showing a main part of the signal adjusting apparatus in one preferred embodiment according to the present invention;

FIG. 4 is an enlarged perspective view showing a main part of the signal adjusting apparatus in one preferred embodiment according to the present invention;

FIG. 5 is an enlarged perspective view showing a main part of the signal adjusting apparatus in one preferred embodiment according to the present invention; and

FIG. 6 is a block diagram showing a control system of the signal adjusting apparatus in one preferred embodiment according to the present invention.

### DETAILED DESCRIPTION OF THE PREFERRED EMBODIMENTS

One preferred embodiment of the signal adjusting apparatus according to the present invention will now be described in detail in accordance with the accompanying drawings.

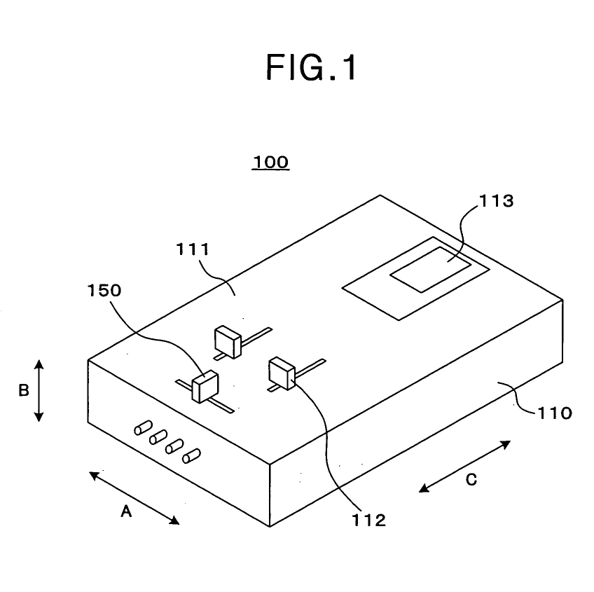

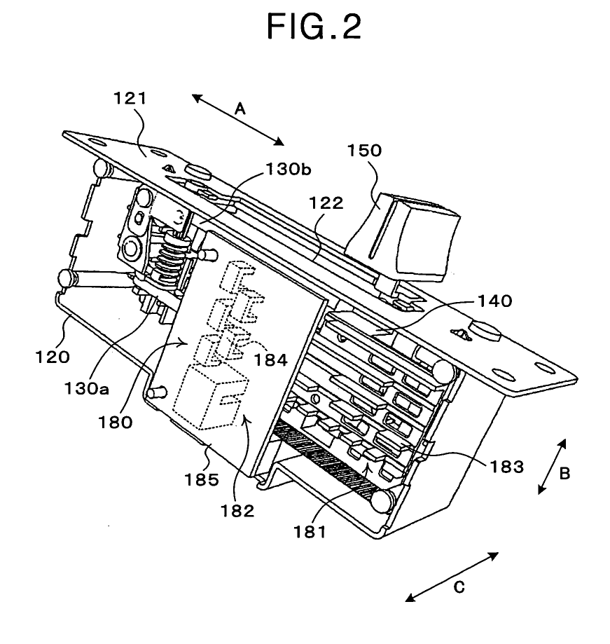

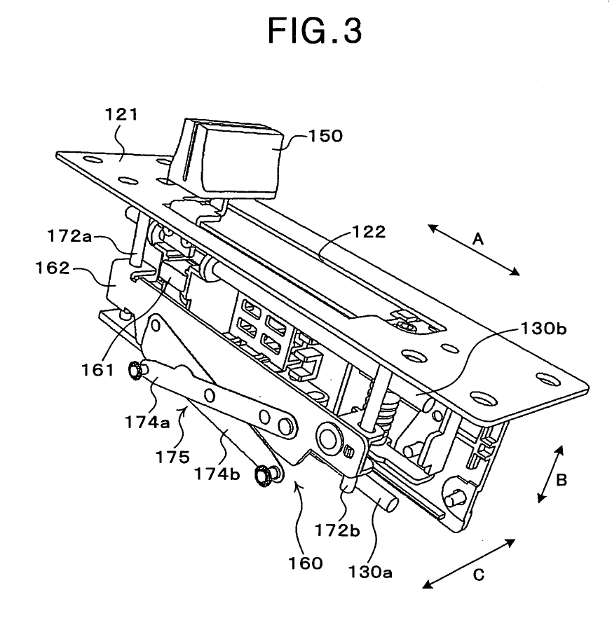

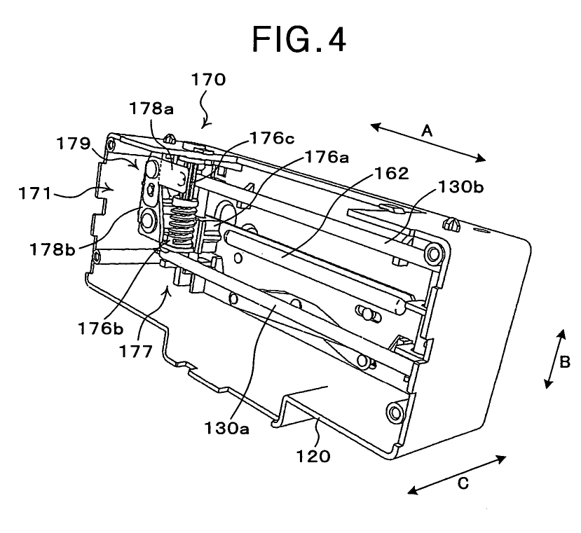

Referring now to the drawings, in particular to FIGS. 1 to 6, there is shown one preferred embodiment of the signal adjusting apparatus according to the present invention.

The construction of the signal adjusting apparatus in this embodiment will be described hereinafter.

The signal adjusting apparatus in this embodiment is applied to an audio mixer which is operative to adjust an audio signal.

In this embodiment, while the signal adjusting apparatus according to the present invention is applied to an audio mixer used for a variety of audio instruments, the signal adjusting apparatus according to the present invention may be applied to a controller used for a variety of robot instruments, a controller used for a variety of game machines, an interface used for a variety of electric musical instruments, and so on.

As shown in FIGS. 1 to 4, the signal adjusting apparatus 100 in this embodiment comprises a main body 110 which is in the form of a box shape, a case member 120 which is accommodated in a front part of the main body 110, a pair of support members 130a and 130b each of which is in the form of a rod shape and attached to the case member 120, a movable member 140 which is supported by the support members 130a and 130b and movable in a movable range, an operation lever (fader) 150 which is in the form of a knob shape and connected to the movable member 140, a load putting device 160 which puts a load to the movable member 140, and a load adjusting device 170 which adjusts the magnitude of the load putted to the movable member 140.

In addition to the operation lever 150, the main body 110 is equipped with a plurality of operation levers 112 each of which operates a variety of functions, a display unit 113 which displays a variety of pieces of information, and so on. The main body 110 has an operation surface 111 thereon.

In the following description, the main body 110 has a width direction (hereinafter referred to as “A direction”), a height direction (hereinafter referred to as “B direction”), and a depth direction (hereinafter referred to as “C direction”), and these directions are described in the drawings.

The case member 120 is equipped with a panel member 121 which is in the form of a plane shape and attached to the case member 120. The panel member 121 is formed with an opening 122 which extends in the A direction.

The operation lever 150 outwardly projects from the main body 110 through the opening 122 of the case member 120 to be handled by fingers of a user.

The support members 130a and 130b are arranged in parallel with each other along the A direction, and arranged in parallel with the panel member 121. The movable member 140 is movable in a movable direction, i.e. the A direction along the support members 130a and 130b.

The load putting device 160 includes a magnet member 161 which is fixed to the movable member 140, and a metal plate 162 as an example of a magnetic substance which extends in the A direction.

The load putting device 160 puts the load to the movable member 140 under the state that the movable member 140 is movable in the movable range with the magnet member 161 attracting the metal plate 162 by the magnetic force of the magnet member 161. Therefore, the load putted to the movable member 140 is increased in the case that the distance between the magnet member 161 and the metal plate 162 is small, and the load putted to the movable member 140 is decreased in the case that the distance between the magnet member 161 and the metal plate 162 is large.

The load adjusting device 170 includes an adjusting member 171 which moves the metal plate 162 to vary the distance between the magnet member 161 and the metal plate 162.

The adjusting member 171 has a supporting portion which consists of a pair of shafts 172a and 172b, a linking portion 175 which consists of a pair of arms 174a and 174b, a setting portion 177 which consists of a rack gear 176a, a worm gear 176b and a rotating shaft 176c, and a holding portion 179 consists of a spring plate 178a and a holding plate 178b.

The shafts 172a and 172b are arranged in parallel with each other along the B direction, and arranged in perpendicular to the panel 121. The metal plate 162 is supported by the shafts 172a and 172b, and movable in the B direction along the shafts 172a and 172b.

In this embodiment, while the metal plate 162 is movable in the B direction, the metal plate 162 may be movable in the C direction.

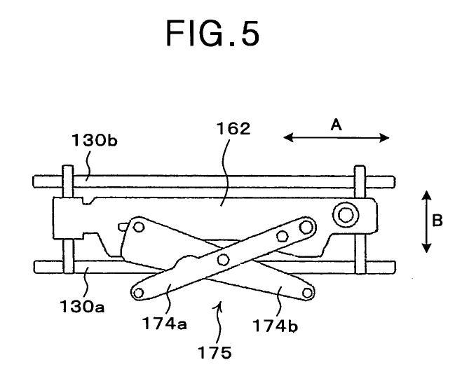

As shown in FIG. 5, the linking portion 175 links the metal plate 162 to be arranged in parallel with the A direction. Specifically, the metal plates 162 is arranged in parallel with the A direction under the state that the arms 174a and 174b, which cross each other, are rotated to expand and contract the distance between both ends of the arms 174a and 174b in the B direction The setting portion 177 arbitrarily sets the distance between the magnet member 161 and the metal plate 162. Specifically, the fact that the rotating shaft 176c, which is formed at one end with a groove engaged with a screwdriver and so on, is rotated by the user leads to the facts that the worm gear 176b connected to the rotating shaft 176c is rotated, the rack gear 176a engaged with the worm gear 176b is moved in the B direction, and the metal plate 162 attached to the rack gear 176a is moved in the B direction. These facts enable the setting portion 177 to arbitrarily set the distance between the magnet member 161 and the metal plate 162.

At this point, the fact that one end of the rotating shaft 176c is exposed onto the operation surface 111 of the main body 110 leads to the fact that the magnitude of the load putted to the operation lever 150 can be adjusted under the state that the operation lever 150 is handled, i.e. the operation lever 150 is moved, by the user.

The holding portion 179 holds the distance between the magnet member 161 and the metal plate 162 constant. Specifically, the fact that the convex portion of the spring plate 178a fixed to the holding plate 178b is engaged with the concave portion of the rotating shaft 176c leads to the fact that the rotating shaft 176c cannot be rotated unnecessarily. The fact enables the holding portion 179 to hold the distance between the magnet member 161 and the metal plate 162 constant.

In the signal adjusting apparatus 100 described above, the movable member 140 is movable in the A direction within a predetermined movable range (for example, 45 mm) under the state that the operation lever 150 is handled by the user in the A direction. At this point, the load in accordance with the distance between the magnet member 161 and the metal plate 162 is putted to the movable member 140.

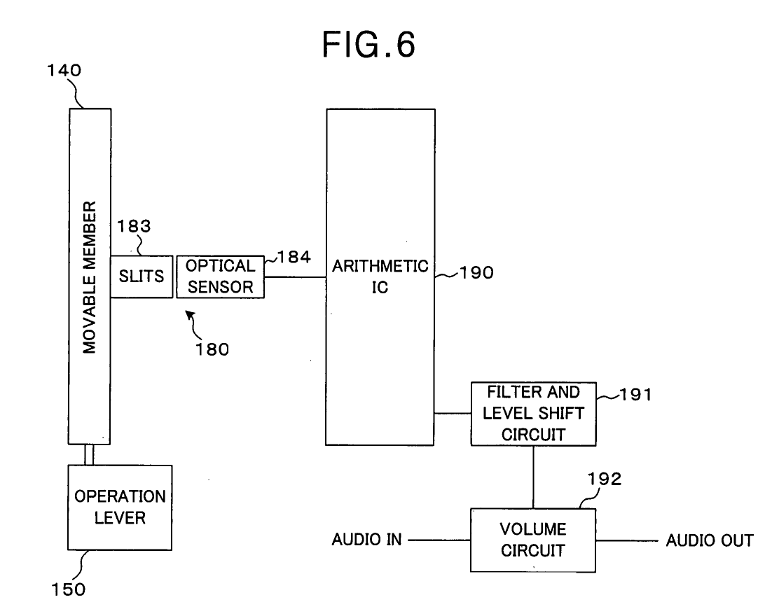

As shown in FIG. 6, the signal adjusting apparatus 100 further comprises a linear encoder 180 which detects a position of the movable member 140, an arithmetic IC (Integrated Circuit) 190 which adjusts the audio signal based on the position of the movable member 140 detected by the linear encoder 180, a filter and level shift circuit 191 which converts an adjustment signal from the arithmetic IC 190 into analog potential, and a volume circuit 192 such as VCA (Voltage Controlled Amplifier) which adjusts the volume level of the audio signal based on the analog potential from the filter and level shift circuit 191.

The arithmetic IC 190, the filter and level shift circuit 191, the volume circuit 192, and so on are mounted on a circuit board (not shown) which is accommodated in the main body 110.

The linear encoder 180 is the so-called non-contact type of positional sensor which is constituted by a movable portion 181 attached to the movable member 140 and a fixed portion 182 attached to the case member 120 to be spaced apart from the movable portion 181.

Specifically, the movable portion 181 consists of a member which is formed with a plurality of slits 183. The fixed portion 182 consists of an optical sensor 184 which detects the slits 183 of the movable portion 181 and a circuit board 185 which holds the optical sensor 184.

The arithmetic IC 190 is operative to recognize the position of the movable member 140 based on a detection signal from the optical sensor 184, and is operative to output the adjustment signal, which is used for adjusting the volume level of the audio signal, to the filter and level shift circuit 191 in the form of a digital signal such as a PWM (Pulse Width Modulation) signal based on the position of the movable member 140.

As described above, in this embodiment, the fact that the magnitude of the load putted to the movable member 140 is adjusted by the load adjusting device 170 leads to the fact that the magnitude of the load putted to the operation lever 150 can be adjusted in accordance with the user's preference.

In this embodiment, the fact that the load putting device 160 is constituted by the magnet member 161 and the metal plate 162 leads to the fact that the signal adjusting apparatus 100 can be simplified in structure, and can reduce the production cost.

In this embodiment, the fact that the load adjusting device 170 is constituted by the adjusting member 171 which moves the metal plate 162 leads to the fact that the signal adjusting apparatus 100 can be simplified in structure, and can reduce the production cost.

In this embodiment, the fact that the metal plate 162 is arranged in parallel with the A direction by the linking portion 175 leads to the fact that the load can be uniformly putted to the movable member 140 to improve the feeling of the operation.

In this embodiment, the fact that the distance between the magnet member 161 and the metal plate 162 is arbitrarily set by the setting portion 177 leads to the fact that the distance between the magnet member 161 and the metal plate 162 can be easily varied to improve the feeling of the operation.

In this embodiment, the fact that the distance between the magnet member 161 and the metal plate 162 is held at constant by the holding portion 179 leads to the fact that the distance between the magnet member 161 and the metal plate 162 cannot be varied unnecessarily to improve the feeling of the operation.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-207948 filed on Aug. 19, 2003 including the specification, claims, drawings and summary is incorporated herein by reference in its entirety.

1. A signal adjusting apparatus which adjusts an electrical signal, comprising:
a movable member which is movable in a movable range to have the electrical signal adjusted in accordance with a position of the movable member;
a load putting device which puts a load to the movable member under the state that the movable member is movable in the movable range; and
a load adjusting device which adjusts the magnitude of the load putted to the movable member.

2. The signal adjusting apparatus according to claim 1, wherein the load putting device includes a magnet member which is fixed to the movable member, and a magnetic substance which extends in a movable direction of the movable member.

3. The signal adjusting apparatus according to claim 2, wherein the load adjusting device includes an adjusting member which moves the magnetic substance to vary a distance between the magnet member and the magnetic substance.

4. The signal adjusting apparatus according to claim 3, wherein the adjusting member has a linking portion which links the magnetic substance to be arranged in parallel with the movable direction of the movable member.

5. The signal adjusting apparatus according to claim 3, wherein the adjusting member has a setting portion which arbitrarily sets the distance between the magnet member and the magnetic substance.

6. The signal adjusting apparatus according to claim 3, wherein the adjusting member has a holding portion which holds the distance between the magnet member and the magnetic substance constant.
